(19) United States
(12) Patent Application Publication
(10) Pub. No.: US 2006/0026125 A1
(43) Pub. Date: Feb. 2, 2006

(54) Accessing entity data from a UDDI registry

(76) Inventor: Robert John Breeds, Swindon (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/186,317

(22) Filed: Jul. 21, 2005

(30) Foreign Application Priority Data
Jul. 28, 2004 (GB) 0416763.1

(51) Int. Cl. G06F 17/30

(52) U.S. Cl. 707/2

(57) ABSTRACT

The invention provides a method, a UDDI registry, and a computer program product for accessing a UDDI entity defined by a tModel. A uddi-org:general_keywords keyedReference is added to the tModel to provide a value that may be used in order to access data associated with the entity. Accordingly, this is read and used when accessing the data. Further, a second uddi-org:general_keywords keyedReference may be added to the tModel to provide a value that may be used to display in a GUI tool in order to represent the entity. Accordingly, this value is read and displayed on a GUI tool in order to represent the entity.

### FIELD OF THE INVENTION

The invention relates to UDDI entities defined using tModels and more particularly to a UDDI registry accessing data associated with a UDDI entity.

### BACKGROUND OF THE INVENTION

Over recent years it has become commonplace for a business to provide the ability for a user to purchase goods from it using a computer that communicates with a computer of the business. For example a business may provide a web site on the Internet that enables a user to purchase goods over the world wide web. Following on from this success, it has become a requirement to more easily locate suitable businesses, or web service providers, to deal with. This requirement has been satisfied by the arrival of registry services, such as specified by UDDI (Universal Description, Discovery and Integration), which provide support for business entities that provide web services.

UDDI is an industry effort to provide directory services for web services offered by businesses, or other web service providers. A UDDI registry provider provides a registry in which businesses can publish their web services and from which other business representatives/clients can locate and form business relationships with partners based on the web services that they provide. The UDDI specification provides structural templates for representing information about business entities, the nature of their services, and mechanisms to locate and access them. These are facilitated by standards such as Web Services Definition Language (WSDL), and Simple Object Access Protocol (SOAP).

In a UDDI registry entities are defined by and contained within, logical structures such as businessEntity, businessService, bindingTemplate and tModel. For example, a business or organization that provides web services is defined using businessEntity. The businessEntity describes and categorizes the business, or even the department or machine that offers the services. As a top level entity, the businessEntity can contain multiple businessService entities. The businessService structure describes and classifies a logical grouping of web services. The businessService can contain bindingTemplate entities and it is the bindingTemplate that represents an individual web service. That is, the bindingTemplate specifies the technical information that applications use to bind and interact with the service. The bindingTemplate includes the access point for the service. Technical models, or tModels for short, are used in UDDI to represent unique concepts or constructs. TModels exist outside of the parent-child containment relationships between the businessEntity, businessService and bindingTemplate structures.

Each distinct specification, transport, protocol, namespace, categorization, and address format that can be applied to the other UDDI entities is represented by a tModel. UDDI registries provide a standard set of tModels. If a new concept or standard is required to help describe a business or service, a new tModel can be published. References to specific tModels can be placed in any of the UDDI entities using container structures called categoryBag, identifierBag, and tModelBag. The references are called keyedReferences because they specify the unique ID of the tModel. TModels that contain a keyedreference to a tModel that represents a categorization system are known as categorization tModels and represent classification systems, or taxonomies. By referencing these types of tModel, businessEntity, businessService and bindingTemplate may be categorized. UDDI provides an inquiry mechanism that allows service requesters to discover entities that match a specific set of criteria, including categorization systems. For each taxonomy in UDDI, there must be a tModel to describe it and a set of valid values that represent the allowed category values.

UDDI provides both standardized taxonomies, such as North American Industry Classification System (NAICS) and United Nations Standard Product and Services Classification (UNSPSC), and facilities by which additional taxonomies, so called custom taxonomies, can be provided. Through custom taxonomies, a UDDI registry can provide a richer set of categories for businesses and clients to classify the services that they provide and require, respectively.

A Custom taxonomy is defined to a UDDI registry using a tModel, which comprises a set of defined fields set to valid values. For a taxonomy tModel the set of defined fields define a tModel key, a tModel name, a tModel description, and that the tModel defines a taxonomy. For example, the tModel key is set to a UUID (Universal Unique Identifier) to uniquely identify the tModel, the tModel Name is set to a URI (Universal Resource Identifier) to uniquely identify the taxonomy, and the tModel description is set to a string that provides a textual description of the taxonomy. However, the tModel must further provide information that enables the taxonomy data to be accessed and, as a result, the existing fields must also be used for this purpose. This requires that either the use of one of the defined fields is changed to a purpose for which it was not intended such that, for example, the tModel name specifies a database key that is used to access the taxonomy data, or the database that contains the taxonomy data is changed to use a database key that is the same as the URI value to which the tModel name field is set. Accordingly, either the intended purpose of the tModel name field is lost or the taxonomy must be stored in the database using an overcomplicated key.

Further, a UDDI registry provider may also provide a Graphical User Interface (GUI) tool through which a user can, for example, define UDDI entities that define a business and its services to the UDDI registry. To enable this, the GUI tool can provide a facility to assign categories to a particular UDDI entity. For example, a drop down list of available taxonomies and their categories may be provided from which one or more category values can be selected. As a result, in this case, the defined fields in a taxonomy tModel must also provide a name that is useful for displaying with a GUI tool. As a result, one of the defined fields must also be used for this purpose which, for example, if the tModel name is used has the effect that either the tModel name is set to a name suitable for a GUI tool instead of a URI or the GUI must use the URI, or some subset of the URI, as a name to display on the GUI tool.

### SUMMARY OF THE INVENTION

According to the present invention, a tModel for a UDDI entity, such as a custom taxonomy, provides at least one additional field using a standard UDDI technique, which can be used to provide information that can be used to access the taxonomy.

According to a first aspect, the invention provides a method for a UDDI registry to access data associated with a UDDI entity, the method including: accessing a tModel that defines the UDDI entity; reading from the tModel a uddi-org:general_keywords keyedReference, wherein the keyedreference defines a value; and using the value to access data associated with the UDDI entity.

According to the second aspect, the invention provides a UDDI registry including: an element that accesses a tModel defining a UDDI entity; a reader that reads from the tModel a uddi-org:general_keywords keyedReference, wherein the keyedReference defines a value; and an element that uses the value to access data associated with the UDDI entity.

According to a third aspect, the invention provides a computer program product comprising instructions thaty, when executed on a data processing host, cause the host to carry out a method according to the first aspect.

By using a uddi-org:general_keywords keyedreference, the additional information is added using a standard UDDI mechanism and, as a result, if a UDDI registry that does not implement the invention were to read the UDDI entity, it will simply ignore the additional keyedReference rather than, for example, diagnose an error.

Further, by adding this keyedreference that provides information to access the entity, the existing tModel defined fields, such as the tModel name field, are freed from this purpose and may be used for the purpose for which they were intended, according to the UDDI standard.

Preferably a further uddi-org:general_keywords keyedreference is added to the tModel, the further keyedReference defining a name suitable for displaying in a GUI tool to describe the entity.

Accordingly, the UDDI registry may provide for: reading from the tModel a uddi-org:general_keywords keyedReference, wherein the keyedreference defines a name; and displaying the name on a GUI tool in order to represent the entity.

Optionally, the value that is used to access data associated with the UDDI entity comprises a database key under which the data is stored. Alternatively, it could include a database name and key, or a file name and/or a key.

Note that the UDDI entity could be any entity that is defined using a tModel and that has associated data that is separate from the tModel. For example, the UDDI entity could be a taxonomy that has associated taxonomy data or another type of entity, such as a transport or protocol, that has data associated with it, for example, an image file for displaying as an icon for a UDDI entity in a GUI, or a sound file for associating a voice description with a UDDI entity.

### BRIEF DESCRIPTION OF THE DRAWINGS

The invention will now be described by way of example only, with reference to a preferred embodiment thereof, as illustrated in the accompanying drawings, in which:

FIG. 1 is a block diagram of a data processing environment in which the preferred embodiment of the present invention can be advantageously applied;

FIG. 2 shows a tModel template for defining a taxonomy to a UDDI registry according to the prior art;

FIG. 3 shows values specified in tModels that define standardized taxonomies according to the prior art tModel template;

FIG. 4 shows a tModel template for defining a taxonomy according to the preferred embodiment of the present invention;

FIG. 5 shows an examplary tModel for a custom taxonomy that contains natural food categories according to the preferred embodiment of the present invention;

FIG. 6 shows how the information of the tModel in FIG. 5 is used according to the preferred embodiment of the present invention; and

FIG. 7 is a flowchart of a UDDI Registry processing a tModel according to a preferred embodiment of the present invention.

### DESCRIPTION OF THE PREFERRED EMBODIMENTS

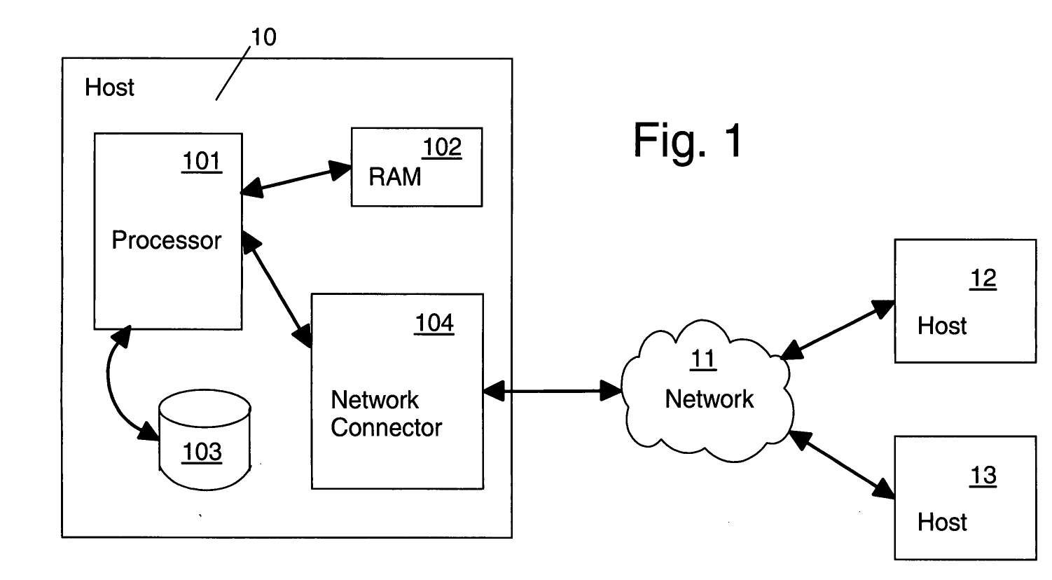

FIG. 1 is a block diagram of a data processing environment in which the preferred embodiment of the present invention can be advantageously applied. In FIG. 1, a client/server data processing host 10 is connected to other client/server data processing host 12 and 13 via a network 11, which could be, for example, the Internet. A UDDI registry and associated GUI tool may be installed on any such client/server and accept requests to access the registry may be received from any client/servers, including the one on which the UDDI registry is installed. Client/server 10 has a processor 101 for executing programs that control the operation of the client/server 10, a RAM volatile memory element 102, a non-volatile memory 103, and a network connector 104 for use in interfacing with the network 11 for communication with the other client/servers 12 and 13.

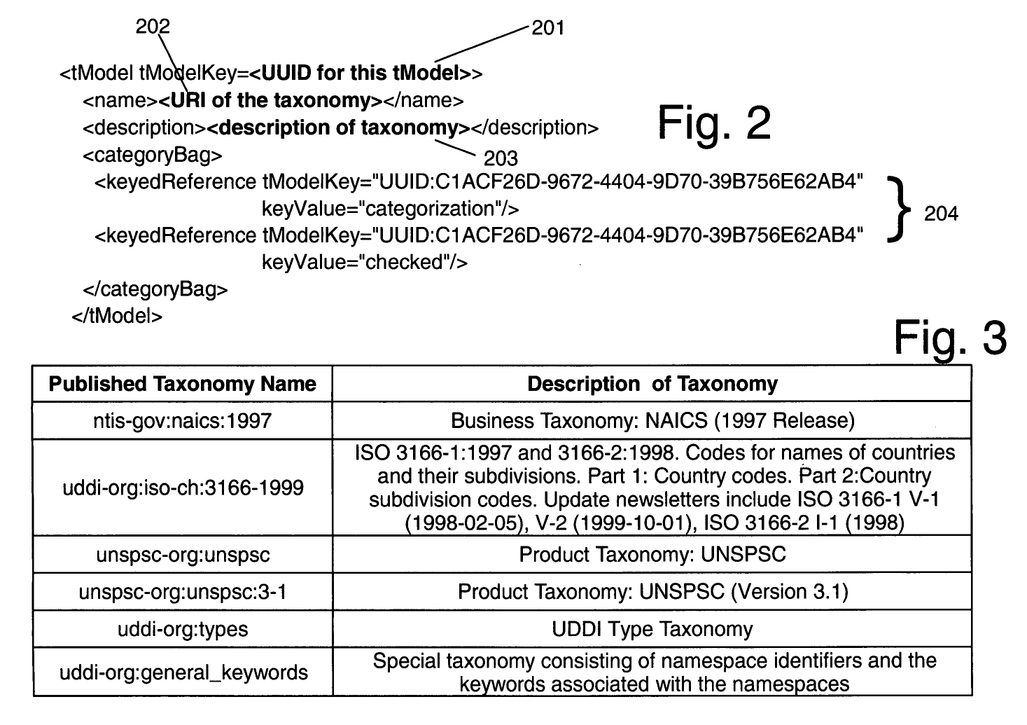

FIG. 2 shows a tModel template for defining a taxonomy tModel to a UDDI registry according to the prior art. The tModel template contains three fields which provide user defined information about the taxonomy tModel. The first field 201 is the tModel key which defines a unique name for the tModel as a UUID, the second field 202 is the tModel name which defines a published name of the taxonomy such as a Uniform Resource Identifier (URI), and the third (optional) field 203 defines an informative description of the taxonomy which is free format string and intended as a comment field in which a more detailed description of the taxonomy can be provided.

As a result, neither the tModel key, name or description are appropriate for defining a means to associate the tModel definition with the taxonomy data which it represents. For example the tModel key (UUID) could be used for this purpose but its value is not known until after the tModel is published and taxonomy data may not necessarily be stored in a database such that it can be associated with it. Alternatively the tModel name could be set to a value which can be associated with the data in the database but then it would be in conflict with the intended function of the tModel name.

Further none of the fields are suitable to provide a name which is easily readable in a GUI tool. For example the tModel name is a URI is a relatively complex string which can be up to 256 characters long, and further, the third field 203 which can be up to 256 characters long, is optional according to the UDDI specification, and further is intended as a description of the taxonomy.

Note that other fields 204 in the tModel are used to specify what the tModel defines and these fields are keyedReferences in the categoryBag section of the tModel. In this example the tModel defines a “categorization” (taxonomy) which in this case is “checked” which means that the taxonomy has a validation service.

Accordingly the information which can be provided by the user in a tModel which defines a taxonomy is somewhat limited and does not provide information which is particularly useful for associating the tModel with a database representation of the taxonomy or for displaying in a GUI tool. For example FIG. 3 shows the contents of the published taxonomy tModel name field 202 and description of taxonomy field 203 of the standardised taxonomies provided for by the UDDI specification. The name fields are provided as a URI and it can be seen from this that, for example, if the taxonomy data was stored under a key, using this name, in a database, the key would need to be unnecessarily complex, and as a result use excessive storage. Further if it was desired to provide a GUI tool from which the user can select a taxonomy and a category from that taxonomy, it would be difficult to select a descriptive name to display for each of the taxonomies from the data available, and also tModels may have multiple descriptions in multiple languages. Note that whilst FIG. 3 shows the problem with a tModel which defines a standardised taxonomy the same problem would exist for a custom taxonomy which would be similarly limited in its use of the tModel name and description fields (202, 203), and further the description field 203 could be omitted.

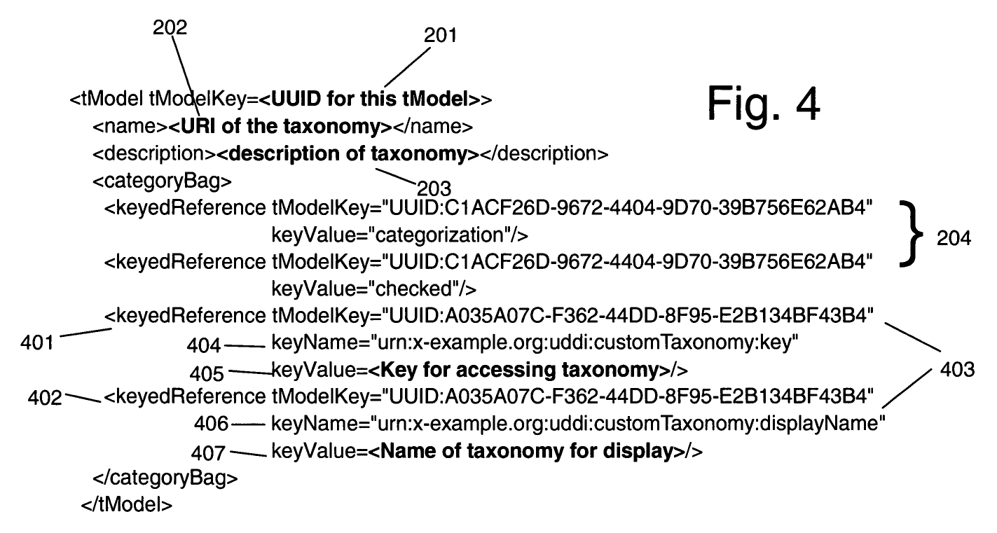

FIG. 4 shows a tModel template which defines a taxonomy according to the preferred embodiment of the present invention. In this tModel template two new keyedReference fields 401, 402 have been added to the categoryBag in a way which is standard according to the UDDI specification. Both of these keyed references specify the same tModel key 403, which indicates that the keyedReference is a uddi-org:general_keywords keyed reference, and a key name (404, 406) and key value (405, 407) which effectively define variable name and value pairs.

The first keyedReference 401 specifies a key name 404 of “urn:x-example.org:customTaxonomy:key” and key value 405 which specifies a value which can be used to access the taxonomy in a database/repository of taxonomies. This value could be used in addition to another field, such as the tModel name, when accessing the taxonomy data or it could provide sufficient information to access the taxonomy data independently of any other fields. For example, the key value 405 could include a file name and/or a file key. Alternatively, for example, the key value could include a database name and/or a database table name and/or a database key.

The second keyed reference specifies a key name 406 of “urn:x-example.org:uddi:customTaxonomy:displayName” and specifies a value which can be used, for example, to display on a GUI tool to specify the Taxonomy. Accordingly the value can be set to a value which is suitable for display on a GUI tool without having to consider a second purpose for which the value may be used.

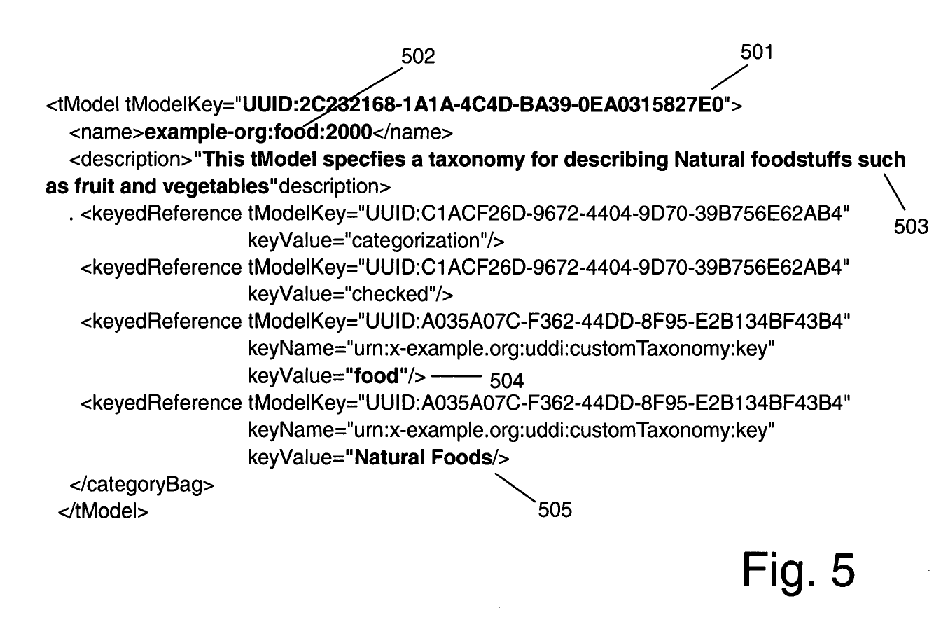

FIG. 5 shows a tModel for a custom taxonomy which contains natural food categories according to the preferred embodiment of the present invention. The tModel key field 501 contains a UUID which provides a unique ID for the tModel, the tModel name field 502 contains a URI of “example-org:food:2000” which provides a meaningful name for the taxonomy tModel, and the description field 503 contains a short sentence which provides a short description of the taxonomy tModel. Note that none of these fields provide any information other than that which is intended according to the UDDI spec. This is because the customTaxonomy:key field 504 provides information which enables the taxonomy to be accessed, which in this example is the key “food” which is used as a key to access a known database, and the customTaxonomy:displayName field 505 provides a short descriptive name for the taxonomy suitable for display in a GUI tool.

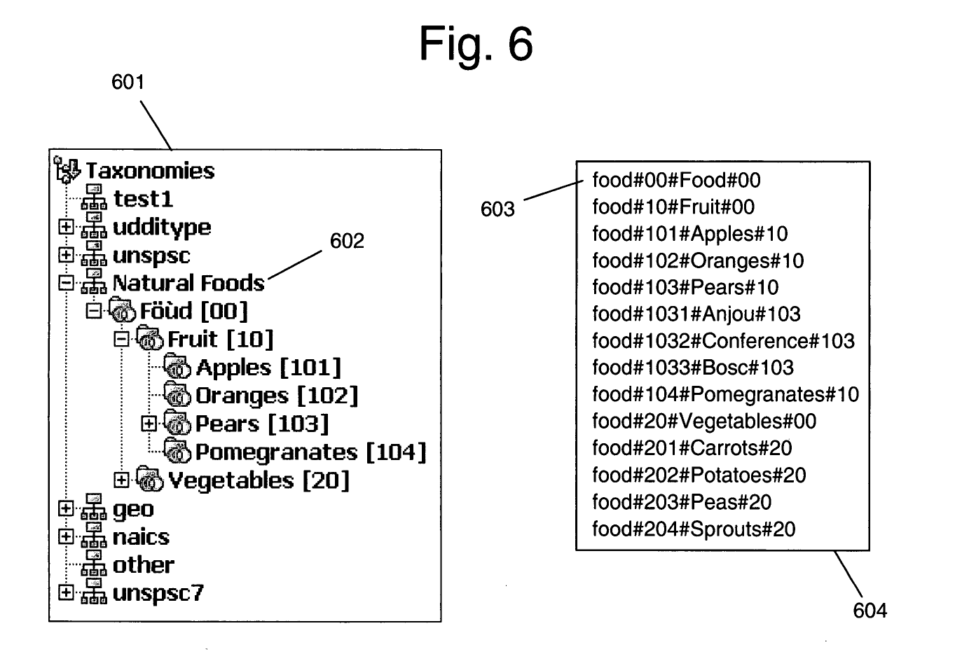

FIG. 6 shows how the information in the natural foods taxonomy tModel is used. The figure shows a display panel 601 of a GUI tool and a database file 604. The GUI tool is provided by the UDDI registry and provides a tree view of taxonomies and, when expanded, the categories which they provide. The database file 604 contains the data associated with Natural Foods taxonomy and which is stored under the key 603 “food” (the first column in the file). The GUI display lists the Natural Foods taxonomy at 602 and uses “Natural Foods” which is the customTaxonomy:displayName value 504 from the tModel of FIG. 5. Further, if the user selects a value from this taxonomy as shown in FIG. 6 the customTaxonomy:key value “food” 503 from the tModel of FIG. 5 is used as a key 603 into the database in order to obtain details of the categories provided by the taxonomy.

Note that although the example shown in FIGS. 5 and 6 is fairly simple it illustrates one of the benefits of the invention. This is that when the data for the taxonomy was first created the format of the data chosen does not have an impact on the tModel name field. As a result the database creator does not need to consider the requirements of the UDDI tModel name field when planning the structure of the database.

Further note that in the example the names provided for the keyedreferences are “urn:x-example.org:uddi:customTaxonomy:key” and “urn:x-example.org:uddi:customTaxonomy:displayName”. In practice the choice of these names is somewhat arbitrary and any name could be chosen which uniquely identifies the purpose of the keyedreference compared to other keyedReference used in tModels defined to the UDDI registry in use. This should be a Uniform Resource Name (URN)—a universal resource identifier which is independent of location.

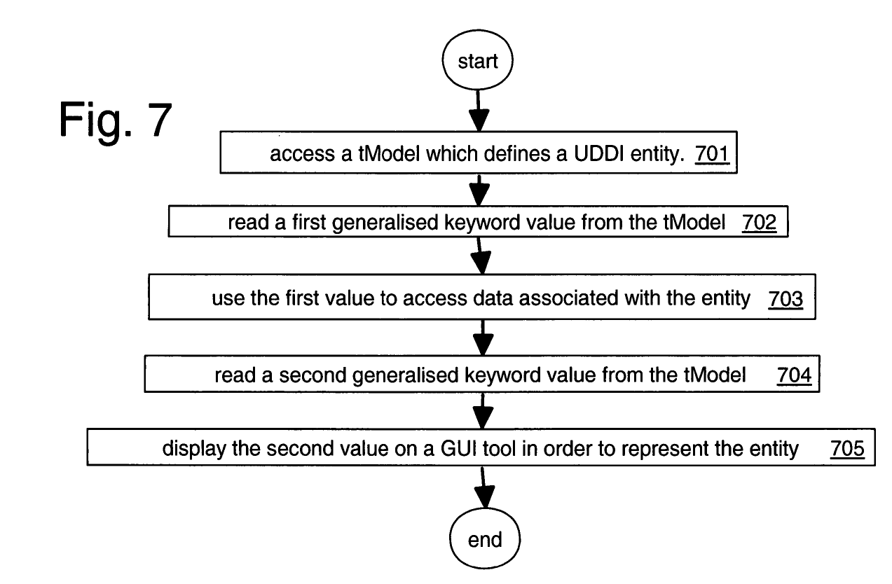

FIG. 7 is a flow chart of a UDDI registry processing a tModel according to a preferred embodiment of the present invention. At step 701 the UDDI registry accesses a tModel which defines a UDDI entity, for example the tModel of FIG. 5 which defines a custom taxonomy. At step 702 a first value, such as 504 of FIG. 5, is read from the tModel. This value is defined as a uddi-org:general_keywords keyedreference and has a name which is recognisable to the UDDI registry as indicating that the value can be used to access data associated with the entity. Accordingly at step 703 the UDDI registry uses the value read in order to access data associated with the entity. At step 704 a second value, such as 505 of FIG. 5, is read from the tModel. This value is defined as a uddi-org:general_keywords keyedReference and has a name which is recognisable to the UDDI registry as indicating that the value is suitable for display on a GUI tool in order to represent the entity. Accordingly at step 705 the UDDI registry uses the value read to display a field in a GUI tool in order to represent the entity.

Note that a skilled person in the art would realise that the method described with reference to FIGS. 7 could be implemented in a variety of programming languages, for example, Java™, C, and C++ (Java is a registered trademark of Sun Microsystems, Inc. in the United States, other countries, or both.), and would further realise that the order of the steps may be varied, for example step 704 could be before step 703. Further a skilled person would realise that once implemented the methods can be stored in a computer program product comprising one or more programs, in source or executable form, on a media, such as floppy disk, CD, and DVD, suitable for loading onto a data processing host and causing the data processing host to carry out the methods. Further a skilled person would realise that the method described with reference to 7 could be embodied in a UDDI registry comprising elements to carry out the method steps. For example a reader could carry out steps 702 and 704.

The invention therefore provides a method, a UDDI registry, and a computer program product for accessing a UDDI entity defined by a tModel. A uddi-org:general_keywords keyedreference is added to the tModel to provide a value which may be used in order to access data associated with the entity. Accordingly this is read and used when accessing the data. Further a second uddi-org:general_keywords keyedreference may be added to the tModel to provide a value which may be used to display in a GUI tool in order to represent the entity. Accordingly this value may be read and displayed on a GUI tool in order to represent the entity.

1. A method for a UDDI registry to access data associated with a UDDI entity, the method comprising the steps:
accessing a tModel defining the UDDI entity;
reading from the tModel a uddi-org:general_keywords keyedreference, the keyedreference defining a value; and
using the value to access data associated with the UDDI entity.

2. The method of claim 1, comprising the further step of:
reading from the tModel a uddi-org:general_keywords keyedReference, the keyedReference defining a name;
displaying the name on a GUI tool in order to represent the entity;

3. The method of claim 1, wherein the value comprises a database key;

4. The method of claim 1, wherein the UDDI entity is a taxonomy.

5. A UDDI registry comprising:
an element that accesses a tModel defining a UDDI entity;
a reader that reads from the tModel a uddi-org:general_keywords keyedReference, the keyedReference defining a value;
an element that uses the value to access data associated with the UDDI entity.

6. The UDDI registry of claim 5 further comprising:
a reader that reads from the tModel a uddi-org:general_keywords keyedReference, the keyedreference defining a name;
an element that displays the name on a GUI tool in order to represent the entity;

7. The method of claim 5, wherein the value comprises a database key;

8. The method of claim 5, wherein the UDDI entity is a taxonomy.

9. A computer usable medium embodying computer program code, the computer program code comprising computer executable instructions configured to:
access a tModel defining the UDDI entity;
read from the tModel a uddi-org:general_keywords keyedreference, the keyedReference defining a value; and
use the value to access data associated with the UDDI entity.

10. The computer usable medium of claim 9, wherein the computer program code further comprises computer executable instructions configured to:
read from the tModel a uddi-org:general_keywords keyedReference, the keyedReference defining a name; and
display the name on a GUI tool in order to represent the entity.

11. The computer usable medium of claim 9, wherein the value comprises a database key.

12. The computer usable medium of claim 9, wherein the UDDI entity is a taxonomy.
